(19) United States
(12) Patent Application Publication
(10) Pub. No.: US 2023/0331636 A1
(43) Pub. Date: Oct. 19, 2023

(54) OXIDATIVE METHOD FOR PREPARING A FERTILIZING COMPOSITION

(71) Applicants: AGRO INNOVATION INTERNATIONAL, SAINT-MALO (FR); ECOLE D'INGENIEURS DE PURPAN, TOULOUSE CEDEX 3 (FR)

(72) Inventors: Florence CRUZ, SAINT-MALO (FR); Sylvain PLUCHON, SAINT-MALO (FR); Jean-Claude YVIN, SAINT-MALO (FR); Frédéric VIOLLEAU, TOULOUSE CEDEX 3 (FR); Guillaume GOTTI, PEZENS (FR); Marielle PAGES-HOMS, TOULOUSE CEDEX 3 (FR)

(21) Appl. No.: 18/044,169

(22) PCT Filed: Sep. 6, 2021
(86) PCT No.: PCT/FR2021/051524

§ 371 Date: Mar. 6, 2023

(30) Foreign Application Priority Data
Sep. 7, 2020 (FR) FR2009050

(51) Int. Cl. C05F 11/02; C05F 17/40

(52) U.S. Cl. CPC C05F 11/02; C05F 17/40

(57) ABSTRACT

The invention relates to a method for preparing a fertilizing composition, comprising a step of treating a liquid composition having humic substances the weight-average hydrodynamic radius of the particles in solution of which, measured by dynamic light scattering (DLS), is the “Hr_{average pre-treatment}” with an appropriate amount of oxidizing agent to obtain a liquid composition having oxidized humic substances the weight-average hydrodynamic radius of the particles in solution (Hr_{average post-treatment}) of which, measured by DLS, is greater than the Hr_{average pre-treatment}; a composition that can be obtained by the method and the use thereof.

### TECHNICAL FIELD

The invention relates to a method for preparing a fertilizing composition by oxidation of humic substances, the compositions thus obtained and the use thereof as a fertilizer. The fertilizing compositions prepared can in particular be used in agriculture, in particular for stimulating the growth of plants.

### PRIOR ART

Humic substances are biomolecules with both macromolecular and supramolecular character [8]. Humic substances are largely responsible for the brown color of decomposed plant debris and also contribute to the black-brown color of soil surfaces. Humic substances are therefore very important components of the soil as they affect the physical and chemical properties of the soil and increase its fertility. In aquatic systems, such as rivers, humic substances make up about 50% of dissolved organic matter. Humic substances affect its pH and alkalinity.

Humic substances are complex and heterogeneous mixtures of polydisperse materials formed by chemical and biochemical reactions during the decomposition and transformation of plants and microbial residues, resulting in a process known as humification. Plant lignin and its transformation products, as well as polysaccharides, melanin, cutin, proteins, lipids, nucleic acids, fine particles of carbonization residues, are important compounds participating in this humification process.

Humic substances are substances with very complex structures which are however considered as fully-fledged chemical entities. According to the definition given by the International Humic Substance Society (IHSS), humic substances are complex and heterogeneous mixtures of polydisperse materials formed in soils, sediments and natural waters by biochemical and chemical reactions during decomposition and transformation of plant and microbial remains (a process called humification).

Humic substances comprise in particular humic acids (HA), fulvic acids (FA) and humin.

The following table is a possible representation of the physico-chemical properties of humic, fulvic acids and humin according to [5].

TABLE 1

| Fulvic acids | | Humic acids | | Humin |
|---|---|---|---|---|
| Pale yellow | Yellow brown | Dark brown | Dark grey | Black |

```
  ------------------------ increase in color intensity ----------------- [symbol]
  ------------------- increase in the degree of polymerization --------------- [symbol]
2000 ----------------- increase in molecular weight -------- 300 000 - [symbol]
45% --------------------- increase in carbon content --------------- 62%- [symbol]
48% ------------------ decrease in oxygen content ---------------- 30% - [symbol]
1400 ---------------- decrease in acidity exchange ------------------- 500 - [symbol]
-------------------- decrease in the degree of solubility ------------------------ [symbol]
```

In the field of agriculture, the use of humic substances has many advantages. In particular, an effective amount of humic substances allows to improve the state of health of the plants and the yield, with in particular a better use of water (reduced water consumption to make the same weight of dry matter), increased length of the roots after germination, better rooting, increased biomass (leaves, stems, flowers and fruits) with better dry matter content, improved precocity of flowering and fruiting [1].

The applicants have demonstrated that the oxidation, for example ozonation, of a composition having humic substances allows to optimize its fertilizing properties, compared to a composition having non-oxidized humic substances. In particular, the applicants have demonstrated that a composition having oxidized humic substances, for example an ozonated composition having humic substances, significantly stimulated the absorption of minerals in the plant, compared to a composition having non-oxidized humic substances, for example a composition having non-ozonated humic substances.

### SUMMARY OF THE INVENTION

The present invention, which finds application in the field of agriculture, aims at providing a new method for preparing a fertilizing composition by oxidation of humic substances, the compositions thus obtained and their use as fertilizer.

According to a first aspect, the invention relates to a method for preparing a fertilizing composition, comprising a step of treating a liquid composition having humic substances the weight-average hydrodynamic radius of the particles in solution of which, measured by Dynamic Light Scattering (DLS), is the “Hr_{average pre-treatment}” with an appropriate amount of oxidizing agent to obtain a liquid composition having oxidized humic substances the weight−average hydrodynamic radius of the particles in solution (Hr_{average post-treatment}) of which, measured by DLS, is greater than the Hr_{average pre-treatment}.

According to a third aspect, the invention relates to a fertilizing composition that can be obtained by the method according to the invention.

According to a fourth aspect, the invention relates to the use of a composition according to the invention as a stimulant for the absorption of minerals in a plant, preferably the minerals are selected from nitrogen, phosphorus, potassium, calcium, magnesium and/or sulfur.

According to a fifth aspect, the invention relates to a method for fertilizing a plant a soil or a growing medium comprising the application to said plant, to said soil or to said growing medium of a composition according to the invention.

According to a sixth aspect, the invention relates to a method for fertilizing a plant, a soil or a growing medium consisting in preparing a fertilizing composition by implementing the method of the invention, and applying, for example directly after the preparation, said fertilizing composition to the plant, to the soil or to the growing medium.

### DETAILED DESCRIPTION

The present invention stems from the surprising advantages demonstrated by the inventors of the effect of oxidation, for example ozonation, on the fertilizing power of a liquid composition having humic substances.

Method for Preparing a Fertilizing Composition

The invention relates to a method for preparing a fertilizing composition, comprising a step of treating a liquid composition having humic substances the weight-average hydrodynamic radius of the particles in solution of which, measured by dynamic light scattering (DLS), is the “Hr_{average pre-treatment}” with an appropriate amount of oxidizing agent to obtain a liquid composition having oxidized humic substances the weight-average hydrodynamic radius of the particles in solution (Hr_{average post-treatment}) of which, measured by DLS, is greater than the Hr_{average pre-treatment}.

The description also relates to a method for improving the fertilizing properties of a composition having humic substances, comprising a step of treating a liquid composition having humic substances the weight-average hydrodynamic radius of the particles in solution of which, measured by dynamic light scattering (DLS), is the “Hr_{average pre-treatment}” with an appropriate amount of oxidizing agent to obtain a liquid composition having oxidized humic substances the weight-average hydrodynamic radius of the particles in solution (Hr_{average post-treatment}) of which, measured by DLS, is greater than the Hr_{average pre-treatment}.

In a particular embodiment, the method comprises the following steps:
a) obtaining a liquid composition having humic substances the weight-average hydrodynamic radius of the particles in solution of which, measured by dynamic light scattering (DLS), is the “Hr_{average pre-treatment}”;
b) treating the liquid composition having humic substances with an appropriate amount of oxidizing agent to obtain an oxidized liquid composition having humic substances the weight-average hydrodynamic radius of the particles in solution (Hr_{average post-treatment}) of which, measured by DLS, is greater at the Hr_{average pre-treatment}.

The terms “fertilizing composition(s)”, “fertilizing substance(s)” or “fertilizing product(s)” are synonyms and designate a composition, a substance, or a mixture of substances, of natural or synthetic origin, applied or intended to be applied to plants or their rhizosphere or to fungi or their mycosphere, alone or mixed with another matter, for the purpose of providing plants or fungi with nutrients or to improve their nutritional efficiency or to stimulate plant nutrition methods independently of the nutrients it contains, for the sole purpose of improving one or more of the characteristics of plants or their rhizosphere such as the efficiency of nutrient use, abiotic stress tolerance, qualitative characteristics or availability of nutrients confined to the soil and rhizosphere. This definition is derived from the definition in European Union Regulation no 2019 1009.

The prior art already describes methods for treating humic substances with oxidizing agents such as ozone [2-4]. However, these methods do not relate to the preparation of fertilizing compositions. The methods for oxidizing humic substances described in the prior art are intended to degrade said substances, in particular for the purpose of cleaning. Consequently, the humic substances are treated with very large amounts of oxidizing agent which strongly degrade the humic substances. Contrary to what is implemented in the prior art, the oxidation in the context of the invention is very mild.

Surprisingly, the inventors realized that a liquid composition having humic substances treated with an appropriate amount of oxidizing agent, for example a small amount of ozone, had fertilizing properties superior to those of a non-treated composition having humic substances.

The inventors have indeed shown that it is possible to improve the fertilizing properties of a liquid composition having humic substances by treating said composition with an appropriate amount of oxidizing agent, for example an appropriate amount of ozone. The inventors have in fact noticed, quite unexpectedly, that mild oxidation of a liquid composition having humic substances increases the weight-average hydrodynamic radius of the particles in solution (Hr_{average}), measured by DLS, and that this increase in the Hr_{average} was associated with an increase in the fertilizing properties of said composition.

Thus, to improve the fertilizing properties of a liquid composition having humic substances, the amount of oxidizing agent must be adapted to obtain a liquid composition having oxidized humic substances the weight-average hydrodynamic radius of the particles in solution (Hr_{average post-treatment}) of which, measured by DLS, is greater than the Hr_{average pre-treatment}, measured by DLS.

The methods of oxidation of humic substances described in the prior art did not allow to highlight this phenomenon of increase in the Hr_{average} because, as explained above, the humic substances are treated with amounts of oxidizing agent much higher than the amounts used for the implementation of the method according to the invention.

Measurement of the Weight-Average Hydrodynamic Radius of Particles in Solution (Hr_{average}) by DLS

DLS (Dynamic Light Scattering) is a technique for analyzing the size of particles present in a liquid composition, by measuring the Hr_{average}. It is the most commonly used measurement technique for analyzing the particle size in the nanometer range.

Briefly, the principle of DLS is based on measurements of scattered light intensity fluctuation due to Brownian motion of particles. The larger a particle, the slower it will move. This phenomenon is described by the Stokes-Einstein law. In practice, the incident laser beam will pass through the analyzed liquid composition. The ray scattered at 90° (the most commonly used angle) will depend on the morphology of the particles. The intensity variation of the scattered ray gives information on the diffusion of the particles and therefore on their size [11]. The values of Hr_{average} are calculated by weighting by the weight percentage of each population.

DLS measurements can be performed with a Dynapro Nanostar (WYATT technology) equipped with a laser (λ=662 nm). The measured scatter intensity range can be 1.36×10⁶ to 3.14×10⁶ counts per second (cps). All measurements can be taken at a 90° detection angle and all reported sizes are averages of 15 sequences of 5 s each. A DLS protocol that can be implemented within the scope of the invention is described in the examples.

In the context of the invention, the DLS analyzes allow to measure the weight-average hydrodynamic radius of the particles in solution, that is to say the weight-average hydrodynamic radius of the particles of the soluble fraction of the liquid composition having humic substances.

As explained below, certain liquid compositions of humic substances may comprise a non-negligible amount of insoluble matter. This is the case, for example, when the liquid composition having humic substances is prepared from a raw matter (for example peat) mixed with water. In this particular case, the person skilled in the art knows that he must carry out the measurements of the Hr_{average} by DLS on the soluble fraction of the liquid composition having humic substances. The soluble fraction can be obtained very easily by separating it from the insoluble fraction, for example by decantation, filtration or by centrifugation. An example of separation of the soluble fraction and the insoluble fraction consists in centrifuging at 4800 rpm for 30 minutes. These parameters allow the insoluble matter to precipitate without however precipitating the soluble particles, in particular the large soluble humic substances.

Liquid Composition Having Humic Substances

The liquid composition having humic substances to be oxidized can be obtained from natural humic substances. It can for example be a raw matter containing humic substances, for example peat, leonardite, lignite, coal or anthracite. Thus, a liquid composition having humic substances can be a liquid composition of peat, leonardite, lignite, coal or anthracite.

Peat is fossil organic matter formed by the accumulation over long periods of time of dead organic matter, mainly plants, in a water-saturated environment. Peat forms most of the soils in peatlands. Peat can be more or less rich in humic substances depending on the degree of decomposition. The degree of decomposition of peat is classified according to the Von Post scale which goes from H1 (least decomposed peat) to H10 (most decomposed peat) [9]. Humus peat, that is to say a peat classified from H6 to H10 according to the Von Post scale, is the preferred peat for implementing the method according to the invention because it is richer in humic substances than peat classified from H1 to H5 according to the Von Post scale.

Leonardite is a rock that can contain more than 90% by weight of humic substances. This rock has undergone more extensive degradation than peat, but less extensive than coal.

Lignite is a sedimentary rock composed of the fossil remains of plants. It is an intermediate rock between peat and coal.

Coal is a sedimentary carbonaceous rock corresponding to a specific quality of charcoal, intermediate between lignite and anthracite. Blackish in color, it comes from the carbonization of plant organisms.

Anthracite is a sedimentary rock of organic origin. It is a grey, blackish and shiny variety of charcoal extracted from the mines.

The liquid composition having humic substances to be oxidized can also be obtained from synthetic humic substances. Synthetic humic substances can for example result from a synthesis process [7] or from the transformation of natural humic substances, in particular by hemisynthesis.

Humic substances can also be extracted from organic matters (peat, leonardite, lignite, coal, anthracite, soils rich in humic substances, composts of vegetable waste, etc.) using an alkaline agent such as sodium hydroxide (NaOH) or potassium hydroxide (KOH) and optionally subjected to purification [10]. Humic substances can in particular be extracted and/or purified by methods well known to the person skilled in the art [5] [10].

The liquid composition having humic substances to be oxidized includes liquid compositions of a salt of humic substances. Among the preferred salts, mention may in particular be made of ammonium salts, sodium salts, potassium salts. Preferably, a potassium salt of humic substances is used, such as potassium humates or potassium salt of humic substances. Salts of humic substances are sold commercially. Mention may be made, for example, of the potassium salt of humic substances marketed by the company Humatex under the brand name Dralig® (CAS 68514-28-3). The product Dralig® is prepared from humic substances extracted from Czech natural oxyhumolite with a high content of humic substances.

The person skilled in the art will have no difficulty in preparing a liquid composition having humic substances from humic substances or from a salt of humic substances. It suffices, for example, to mix humic substances or a salt of humic substances with a solvent such as water. FIG. 5 shows the HPSEC profile of a liquid composition having humic substances which can be used in the method according to the invention (in dotted lines).

The person skilled in the art can easily adapt the concentration of humic substances in the liquid composition as needed, for example by adapting the amount of solvent. The concentration of humic substances in the liquid composition is not limited. It can for example be comprised between 100 and 1000 mg/L, preferably between 400 and 500 mg/L, for example approximately 550 mg/L.

The humic substance purity of the liquid composition having humic substances can also vary, for example depending on the source used. Of course, peat is generally less pure in humic substances than leonardite or a commercial powder of humic substances, such as the product Dralig® (CAS 68514-28-3). In a particular embodiment, the liquid composition having humic substances to be treated comprises at least 50% by dry weight of humic substances, for example at least 60%, at least 70%, at least 80%, at least 85%, at least 90%, at least 95%, or at least 99% by dry weight of humic substances.

Treatment with the Oxidizing Agent

The appropriate amount of oxidizing agent necessary for the implementation of the method can depend on various parameters, such as the nature of the humic substances, the purity of the liquid composition having humic substances, the amount of humic substances to be treated, the nature of the oxidizing agent, etc. Nevertheless, the person skilled in the art will have no difficulty in determining the appropriate amount of oxidizing agent by simply measuring the Hr_{average} by DLS, for example by following the evolution of the Hr_{average} with increasing amounts of an oxidizing agent. These measurements can for example allow to define an amount of oxidizing agent not to be exceeded so that the Hr_{average post-treatment}, measured by DLS, is greater than the Hr_{average pre-treatment}, measured by DLS. Thus, it is easy to determine the appropriate amount of oxidizing agent for a given liquid composition having humic substances and a given oxidizing agent.

FIG. 8B shows the evolution of the Hr_{average}, measured by DLS, with increasing amounts of ozone.

The amount of oxidizing agent can be easily adapted so as to obtain, as far as possible, an Hraverage, measured by DLS, whose value is desired. For example, the amount of oxidizing agent is chosen to obtain a maximum value of Hr_{average}, measured by DLS.

The determination of an appropriate amount of oxidizing agent for the implementation of the method of the invention is therefore within the reach of the person skilled in the art and does not have any particular difficulty. However, some liquid compositions of humic substances may comprise a significant amount of the insoluble matter. This is the case, for example, when treating a raw matter (for example peat) mixed with water. In this particular case, the person skilled in the art knows that in order to analyze the particles in solution by DLS, it is necessary to carry out the DLS measurements on the soluble fraction of the liquid composition comprising humic substances. The soluble fraction can be obtained very easily by separating it from the insoluble fraction, for example by filtration or by centrifugation, as detailed previously in the description.

Of course, once the appropriate amount of oxidizing agent has been determined, it is no longer necessary to follow the aforementioned DLS parameter(s) to implement the method of the invention. It is sufficient to simply treat the liquid composition having humic substances with an appropriate amount of oxidizing agent.

Advantageously, the Hr_{average post-treatment} is at least 2 times higher than the Hr_{average pre-treatment}, preferably at least 3 times, 4 times, 5 times, 6 times higher, for example at least 7 times higher, 8 times higher, 9 times higher, 10 times higher, 15 times higher, 20 times higher, 25 times higher, 30 times higher, 35 times higher, 40 times higher, 45 times higher, 50 times higher, 55 times higher, 60 times higher, 65 times higher, 70 times higher.

The treatment time is not limiting as long as an Hr_{average post-treatment} higher than the Hr_{average pre-treatment} is obtained. In general, the duration of the treatment is comprised between 5 minutes and 10 hours. In fact, the amount of oxidizing agent, and optionally the duration of the treatment, are adapted to the initial amount of humic substances and to the oxidizing agent used. The duration of the optimal treatment can therefore be easily adapted by the person skilled in the art.

In a particular embodiment, the weight proportion of particles in solution having a hydrodynamic radius comprised between 15 nm and 10000 nm of the composition having oxidized humic substances, measured by DLS, is at least 2 times greater than the weight proportion of particles in solution having a hydrodynamic radius comprised between 15 nm and 10000 nm of the composition having humic substances before oxidation, preferably at least 2.5 times, for example at least 3 times, at least 3.5 times, at least 4 times, at least at least 4.5 times, at least 5 times, at least 6 times higher.

FIGS. 7 and 8A show the evolution of the weight proportion of particles in solution having a hydrodynamic radius comprised between 15 nm and 10000 nm, measured by DLS, with increasing amounts of ozone.

In another particular embodiment, the weight-average molar weight in solution (hereinafter “Mw”) (expressed in Da) of the liquid composition having oxidized humic substances is greater than the Mw of the composition having humic substances before oxidation.

Mw can be calculated according to the following formula:

$${M}_{w} = \frac{{\sum }_{i = 0}^{n} ( {h}_{i} \times {M}_{i}^{2} )}{{\sum }_{i = 0}^{n} ( {h}_{i} \times {M}_{i} )}$$

with
hi=HPLC signal intensity, and
Mi=molar weight relative to the retention time obtained in HPLC (resulting from the column calibration carried out with standards).

The calculation of Mw is generally done automatically by the HPLC apparatus. To calculate Mw, it is possible to do it manually or to use software such as the Chromeleon software which is an HPLC data acquisition software.

FIGS. 1 and 2 illustrate the increase in Mw with increasing amounts of ozone.

The oxidizing agent is advantageously selected from ozone, ultraviolet rays and/or hydrogen peroxide. The oxidizing agents can be used alone or combined with each other to obtain the desired composition.

The Oxidizing Agent is Ozone

Ozone is a particularly interesting oxidizing agent because it is easy to use, inexpensive and the amount of which is easy to control for the implementation of the method of the invention.

Since ozone is unstable, it is produced at the place of consumption. On an industrial scale, ozone is generally produced by electrical discharges in tubular generators. This production is due to an ozone generator, which is essentially composed of two conductive electrodes held facing each other. The air or oxygen is compressed, then dried, and passes between these two electrodes where it is subjected to an electric discharge in a high voltage alternating current field. Some of the oxygen turns into ozone. A cooling circuit absorbs the excess heat produced by the discharge. To homogenize the discharge, one of the electrodes or sometimes both, are covered with a dielectric with high permittivity, of uniform thickness making an equipotential surface. Generally, the dielectrics used are glasses whose permittivity varies, depending on the chemical composition, from 4 to 6.5. Ozone is therefore produced by causing an oxygenated fluid to slowly circulate in the remaining space and by creating in the gaseous space a sinusoidal alternating voltage of sufficiently high amplitude.

The ozone can be gaseous ozone produced from oxygen, for example from air, from oxygen-enriched air or from pure oxygen. An ozone generator suitable for implementing the invention is Lab2b or CFS1 from the company Ozonia (Suez).

As detailed above, the amount of ozone is adapted to obtain an Hr_{average post-treatment} higher than the Hr_{average pre-treatment}. The amount of ozone will therefore essentially depend on the amount of humic substances present in the composition. In a particular embodiment, the ratio ozone weight/humic substance weight is less than 10. The weight of ozone corresponds to the weight of ozone applied to the liquid composition having humic substances. The weight of humic substances corresponds to the weight of humic substances present in the liquid composition having humic substances to be ozonated, that is to say the weight of humic substances before ozonation. The weight of humic substances can be determined by HPLC. The ratio ozone weight/humic substance weight can for example be less than 9, less than 8, less than 7, less than 6, less than 5, less than 4.5, less than 4, less than 3.5, for example comprised between 0.2 and 10, comprised between 0.2 and 9, comprised between 0.2 and 8, comprised between 0.2 and 7, between comprised 0.2 and 6, comprised between 0.2 and 5, comprised between 0.2 and 3.5, comprised between 0.5 and 3.5, comprised between 1 and 10, comprised between 1 and 9, comprised between 1 and 8, comprised between 1 and 7, comprised between 1 and 6, comprised between 1 and 5, comprised between 1 and 4, comprised between 1 and 3, comprised between 1 and 2, for example is equal to about 1.5.

Any type of ozonator can be used in the implementation of the method according to the invention. For example, air ozonators (dried air with a dew point of −50° C. to −70° C.), low frequency ozonators (50 Hz) whose unit production per hour is approximately 1 to 3 kg of ozone and medium frequency ozone generators (150 to 600 Hz) whose unit production can reach 60 kg per hour. It is in the latter that the ozone is produced and injected into a reactor, where the composition to be treated is injected beforehand. Mention may be made, for example, of the CFS1 ozone generator from Ozonia, which is particularly adapted for implementing the method according to the invention. It is also possible to use excimers which are good ozone generators.

There are several kinds of reactors. For example, reactors equipped with porous diffusers, reactors equipped with turbines, and U-tube piston flow reactors, equipped with a pump to overcome pressure drops.

Before being injected into the liquid composition having humic substances, the gas containing ozone can be divided into “micro-bubbles”, that is to say bubbling of the ozone, using various materials, for example using porous diffusers disposed in the lower part of the tanks or columns or a hydro-injector ensuring the spraying of the gas directly into the composition to be treated. Said hydro-injector has the advantage of a better rate of dissolution of the ozone in the treated composition. Thus, in a preferred embodiment, the treatment is carried out by bubbling ozone into the liquid composition having humic substances, for example by bubbling from 8×10⁻⁴ to 0.5 grams of ozone per minute (g/35 min), for example from 8×10⁻⁴ g/min to 0.1 g/min, for example from 8.33×10⁻⁴ g/min to 0.1 g/min of ozone, preferably from 1.5×10⁻² g/min to 1.9×10⁻² g/min of ozone. The duration of bubbling depends on the amount of ozone that is to be applied.

In a particular embodiment, the ozone concentration of the liquid composition is constant during the treatment, preferably the ozone concentration ranges from 1 g/m³ to 120 g/m³, advantageously it is equal to approximately 20 g/m³.

Other Steps

The method according to the invention may comprise one or more additional steps, for example one or more steps selected from:
preparing a fertilizing composition comprising the liquid composition having oxidized humic substances or directly using the liquid composition having oxidized humic substances as a fertilizing composition;
drying, for example freeze-drying, the liquid composition having oxidized humic substances; and
granulating the liquid composition having oxidized humic substances or a fertilizing composition comprising the liquid composition having oxidized humic substances.

A fertilizing composition comprising the liquid composition having oxidized humic substances can be prepared by adding, to the composition having oxidized humic substances, a mineral fertilizer, preferably containing one or more minerals selected from nitrogen, phosphorus, potassium, calcium, magnesium and/or sulfur, to the ozonated humic substances. The addition can be done before or after the additional steps mentioned above.

Fertilizing Composition

The invention also relates to a fertilizing composition that can be obtained by the method according to the invention.

Advantageously, the weight-average hydrodynamic radius of the particles in solution (Hr_{average}), measured by DLS, is greater than 50 nm, preferably greater than 75 nm, for example greater than 100 nm, greater than 150 nm, greater than 200 nm, greater than 250 nm, greater than 500 nm, greater than 750 nm, greater than 1000 nm, greater than 1250 nm, greater than 1500 nm, greater than 1750 nm, greater than 2000 nm.

Advantageously, the weight proportion of particles in solution having a hydrodynamic radius comprised between 15 nm and 10000 nm, measured by DLS, is greater than 15%, preferably greater than 20%, for example greater than 25%, greater than 30%, greater than 35%, greater than 40%, greater than 45%, greater than 50%, greater than 55%, greater than 60%, greater than 65%, greater than 70%, greater than 75%, greater than 80%.

Advantageously, Mw of the fertilizing composition according to the invention is comprised between 100 kDa and 300 kDa, for example between 100 kDa and 250 kDa, between 100 kDa and 200 kDa, between 100 kDa and 180 kDa, preferably between 150 kDa and 170 kDa, for example it is about 160 kDa. The majority oxidation reaction of humic substances allows the creation of a primary ozonide on a C═C double bond then the formation of ketone, aldehyde or carboxylic acid functions, as illustrated below:

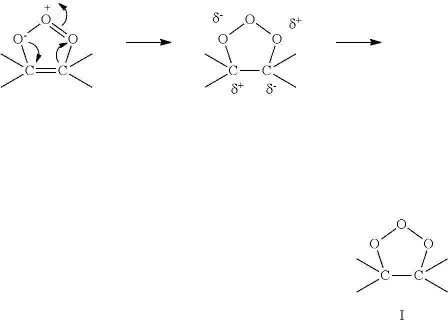

Within the meaning of the invention, the oxidation therefore allows to degrade humic substances into smaller molecules. The diagram of degradation of humic substances by ozone is shown in FIG. 3, taken from [6].

In a particular embodiment, the composition according to the invention also comprises one or more fertilizing substance(s) selected from urea, ammonium sulfate, ammonium nitrate, phosphate, potassium chloride, ammonium sulfate, magnesium nitrate, manganese nitrate, zinc nitrate, copper nitrate, phosphoric acid, potassium nitrate and boric acid.

Preferably, the composition according to the invention further comprises one or more mineral fertilizers. The mineral fertilizer preferably comprises one or more minerals selected from nitrogen, phosphorus, potassium, calcium, magnesium and/or sulfur. It has in fact been shown that oxidized humic substances allow better absorption of minerals by the plant compared to non-ozonated humic substances. A composition according to the invention which further comprises one or more mineral fertilizers therefore has particularly advantageous properties.

FIG. 5 shows the HPSEC profile of a fertilizing composition according to the invention which was obtained by implementing the method according to the invention (solid line).

FIG. 7 shows a DLS profile of fertilizing compositions according to the invention which have been obtained by implementing the method according to the invention, with a ratio ozone weight/humic substance weight (R) equal to 0.1, equal to 0.5 or equal to 2.

The composition according to the invention can be in liquid form, for example in the form of a fertilizing solution, or in solid form, for example in the form of granules.

Use of the Fertilizing Composition and Fertilization Method

The invention also relates to the use of a composition according to the invention as a stimulant for the absorption of minerals in a plant, preferably the minerals are selected from nitrogen, phosphorus, potassium, calcium, magnesium and/or sulfur.

The invention also relates to the use of a composition according to the invention as a stimulant for the production of pigments in a plant, preferably the production of carotenoids, chlorophyll A and/or chlorophyll B.

The invention also relates to a method for fertilizing a plant, a soil or a growing medium comprising the application to said plant, to said soil or to said growing medium of a composition according to the invention.

The invention also relates to a method for fertilizing a plant, a soil or a growing medium, consisting in (i) preparing a fertilizing composition by implementing the method of the invention, and (ii) applying, for example directly after the preparation, said fertilizing composition to the plant, to the soil or to the growing medium.

Within the meaning of the invention, a growing medium is intended to be used as a culture medium for a plant by allowing both to anchor the absorbent organs of the plant and contacting them with the solutions necessary for the growth of the plant.

Advantageously, the method according to the invention allows to stimulate the absorption of minerals in the plant. Preferably the minerals are selected from nitrogen, phosphorus, potassium, calcium, magnesium and/or sulfur.

Advantageously, the method according to the invention allows to stimulate the production of pigments in the plant, preferably the production of carotenoids, chlorophyll A and/or chlorophyll B.

Advantageously, the use or the method according to the invention allows to increase the photosynthetic activity of a plant and/or to stimulate the aerial and/or root growth of the plant.

In a particular embodiment, the fertilizing composition is applied to the plant, to the soil or to the growing medium, in liquid form, directly after the treatment with the oxidizing agent. In this embodiment, the application can be done continuously, that is to say that the fertilizing composition in liquid form is applied to the soil or to the growing medium in a continuous flow throughout the treatment with the oxidizing agent.

The composition according to the invention can be applied to the plant through the leaves or the roots.

In a particular embodiment, the soil is an acid soil. In agriculture, an acid soil is a soil with a pH below pH 6.5. The inventors have in fact shown that under acid conditions the ozonated humic substances precipitate less than the non-ozonated humic substances, and that they therefore retain their fertilizing properties.

The present invention finds application in the treatment of a very wide variety of plants. Among said plants, mention can in particular be made of:
field crops such as cereals (for example wheat, corn),
protein crops (for example peas),
oilseeds (for example soybeans, sunflowers),
grassland plants useful for animal feed,
specialized crops such as, in particular, market gardening (for example lettuce, spinach, tomato, melon), vines, arboriculture (pear, apple, nectarine), or horticulture (for example roses).

### DESCRIPTION OF FIGURES

FIG. 1 is an HPSEC curve which shows the evolution of the weight-average molar weight in solution (Mw) of the liquid composition having humic substances during the treatment with ozone. The figure also shows the evolution of the number-average molecular Weight (Mn) of the liquid composition having humic substances during treatment with ozone.

FIG. 2 is an HPSEC curve which shows the evolution of the weight-average molar weight in solution (Mw) of the liquid composition having humic substances as a function of the ratio “ozone weight/humic substance weight”. The figure also shows the evolution of the Number-Average Molecular Weight (Mn) of the liquid composition having humic substances as a function of the ratio “ozone weight/humic substance weight”.

FIG. 3 shows the oxidative method for degrading humic substances with ozone.

FIG. 4 illustrates the assembly of a batch reactor used for the ozonation of a liquid composition having humic substances.

FIG. 5 is an HPSEC profile of a composition having ozonated humic substances (parent composition of Example 1) and a composition having non-ozonated humic substances (control composition of Example 1). The solid line shows the ozonated composition and the dotted line shows the non-ozonated control composition.

FIG. 6 is a histogram obtained from the HPSEC data of FIG. 5 which shows the percentage of the different families of humic substances according to their molecular weight.

FIG. 7 is a DLS (Dynamic light scattering) analysis that shows the change in size of humic substances with increasing amounts of ozone. The figure shows the appearance of molecules of humic substances with a larger hydrodynamic radius (Hr) (particle families 2 and 3) with a ratio ozone weight/humic substance weight (R) equal to 0.1, R=0.5 and R=2. With R=8, a degradation of large humic substances (family 3) into smaller molecules (families 1 & 2) is observed.

FIG. 8A is a histogram obtained from the DLS data in FIG. 7 that shows the weight distribution of humic substances as a function of their hydrodynamic radius (Hr) with increasing amounts of ozone. The figure shows that the weight proportion of particles in solution with a size comprised between 15 nm and 10000 nm increases when the ratio ozone weight/humic substance weight (R) is equal to 0.1, R=0.5 and R=2.

FIG. 8B is a histogram obtained from the DLS data in FIG. 7 that shows the weight-average hydrodynamic radius of particles in solution (Hr_{average}) with increasing amounts of ozone. The figure shows that the Hr_{average} increases when the ratio ozone weight/humic substance weight (R) is equal to 0.1, R=0.5 and R=2.

FIG. 9 is a curve which compares the evolution of the length of the leaves of maize treated with a composition having ozonated humic substances (1.5×2+SN) and a composition having non-ozonated humic substances (T×2+SN).

FIG. 10 shows the average length of the leaves of maize treated with a composition having ozonated humic substances (1) and a composition having non-ozonated humic substances (0).

FIG. 11 is a curve which compares the evolution of the length of the roots of maize treated with a composition having ozonated humic substances (1.5×2+SN) and a composition having non-ozonated humic substances (T×2+SN).

FIG. 12 shows the average length of the roots of maize treated with a composition having ozonated humic substances (1) and a composition having non-ozonated humic substances (0).

FIG. 13 is a histogram which compares the length of the roots of maize treated with a composition of minerals, a composition having non-ozonated humic substances (T×2+SN), a composition having ozonated humic substances with a ratio “ozone weight/humic substance weight” of 0.5 (0.5×2+SN), a composition having ozonated humic substances with a ratio “ozone weight/humic substance weight” of 1.5 (1.5×2+SN) and a composition having ozonated humic substances with a ratio “ozone weight/humic substance weight” of 3.5 (3.5×2+SN).

FIG. 14 is a histogram comparing the carotenoid content of maize leaves treated with a composition having ozonated humic substances (left) and a composition having non-ozonated humic substances (right).

FIG. 15 is a histogram comparing the chlorophyll A content of maize leaves treated with a composition having ozonated humic substances (left) and a composition having non-ozonated humic substances (right).

FIG. 16 is a histogram comparing the chlorophyll B content of maize leaves treated with a composition having ozonated humic substances (left) and a composition having non-ozonated humic substances (right).

FIG. 17 is an HPSEC profile of a liquid composition having non-ozonated humic substances before and after freeze-drying.

FIG. 18 is an HPSEC profile of a liquid composition having ozonated humic substances before and after freeze-drying.

FIG. 19 is a curve showing the precipitation of humic substances as a function of pH in a liquid composition having ozonated humic substances (in solid lines) and in a liquid composition having non-ozonated humic substances (in dotted lines).

### EXAMPLES

### Example 1: Materials and Methods

Method for Preparing a Fertilizing Composition

A liquid composition having humic substances was obtained by diluting 11 grams of a potassium salt powder of humic substances (Dralig® product marketed by the company Humatex—CAS 68514-28-3) in 20 liters of water, to obtain 20 liters of a composition with a concentration of humic substances of 550 mg/L. This liquid composition having humic substances was used in the examples below as “control composition”.

The ozonation reaction was carried out in a conventional batch reactor described in FIG. 4. The reactor used was a simple glass bottle (1) containing 1 L of the composition having humic substances at 550 mg/L (2). This solution was stirred with a magnetic stirrer (3). The ozone was produced with an ozonizer (CFS1—Ozonia) supplied by pure oxygen (4). The ozone concentration used was 20 g/m³ in the gas flow entering the reactor (with a flow rate of 1.67×10⁻² g/min of ozone) and was monitored using the ozone analyzer (5). The flow of gas entering the reactor was regulated at 50 L/h using a flow meter (6). The temperature of the incoming gas was measured with a thermometer (7) and was comprised between 17 and 22° C. The gas was injected into the composition having humic substances with a glass inlet and a sinter including pores of an average size of 200 μm (8). The excess ozone was then destroyed in a second reactor (9) containing a 50 g/L solution of potassium iodide (KI) (10). A valve was used in order to control the reaction (11). When the ozone was not used in the reactor, it was sent directly to the destroyer (9).

The ozonation time was 50 minutes for 1 L of composition having humic substances at 550 mg/L.

The pH of the composition having humic substances thus treated with ozone was then adjusted to pH=7.0 with a 0.1 mol/L hydrochloric acid solution and, if necessary, with a 0.1 mol/L sodium hydroxide solution.

Compositions having ozonated humic substances were diluted one quarter with MilliQ water. The liquid composition having humic substances thus obtained was used in the examples below as “parent composition”.

DLS Measurements

DLS measurements were performed with a Dynapro Nanostar (WYATT technology) equipped with a laser (λ=662 nm). The measured scatter intensity range was 1.36×10⁶ to 3.14×10⁶ counts per second (cps). All measurements were taken at a 90° detection angle and all sizes reported are averages of 15 sequences of 5 seconds each. The reproducibility of the samples was analyzed 3 times. 20 μL of each solution was used and all solutions were adjusted to 25° C. in the sample chamber of the instrument and allowed to equilibrate for 5 min. A disposable microcuvette (WYATT technology) was used to perform the DLS measurement. Dynamics software (WYATT technology) was used to control the acquisition of measurements and analyze the data.

### Example 2: Characterization of the Fertilizing Composition

The compositions having control humic substances (that is to say before ozonation) and ozonated according to Example 1 (parent composition) were analyzed by HPSEC. This analysis was made using a Dionex Ultimate 3000 channel equipped with a TSK G2000SW_{XL} column (Phenomenex, USA—7.5×300 mm). The channel had an automatic sampler and an isocratic pump. Two detectors were used: a UV-Visible detector with a detection wavelength set at 254 nm (analysis of C═C double bonds) and an R Optilab T-rEX detector (WYATT Technology). The eluent used was a 10 mM acetic acid/sodium acetate mixture with the pH fixed at 7. The eluent was filtered at 0.45 μm and 0.1 μm. The flow rate used was 1 mL/min. The sample injection volume was 20 μL.

The control composition and the parent composition were also analyzed by DLS

(Dynamic light scattering). DLS is an analytical technique based on the Brownian motion of particles, described by the Stokes-Einstein equation. It has been used to study the aggregation of humic substances. In addition, the DLS allowed to determine the hydrodynamic radius (Hr) and the polydispersity of humic substances in solution.

DLS experiments were performed with a Dynapro Nanostar 22 (WYATT technology) equipped with a laser (λ=662 nm). The measured scattering intensity range was 1.36×10⁶-3.14×10⁶ counts per second (cps). All measurements were taken at a 90° detection angle and all sizes reported are averages of 15 sequential runs of 5 seconds each. Samples were analyzed 26 times for reproducibility. 20 μL of each composition was used and all solutions were adjusted to 25° C. in the measuring chamber and allowed to equilibrate for 5 min. A disposable microcuvette (WYATT technology) was used to perform the DLS analysis. Dynamics software (WYATT technology) was used to control the acquisition of measurements and analyze the data.

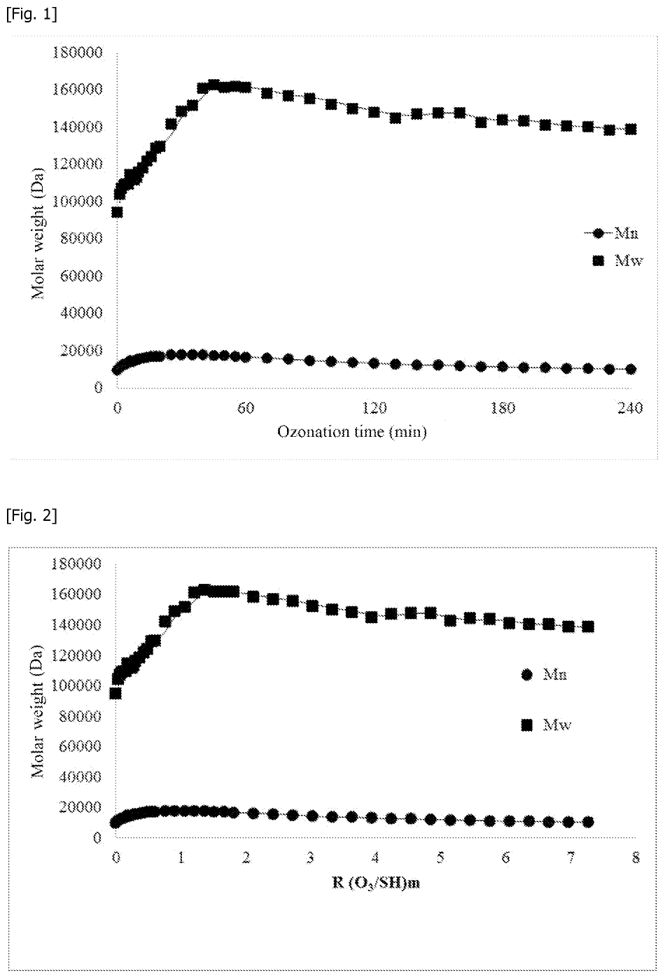

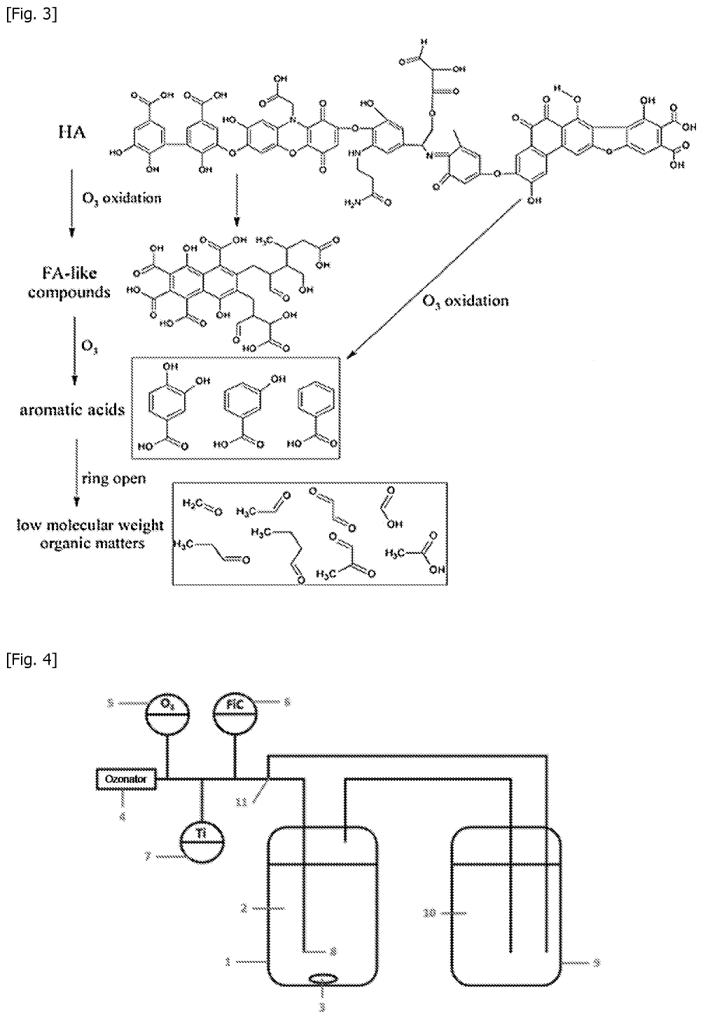

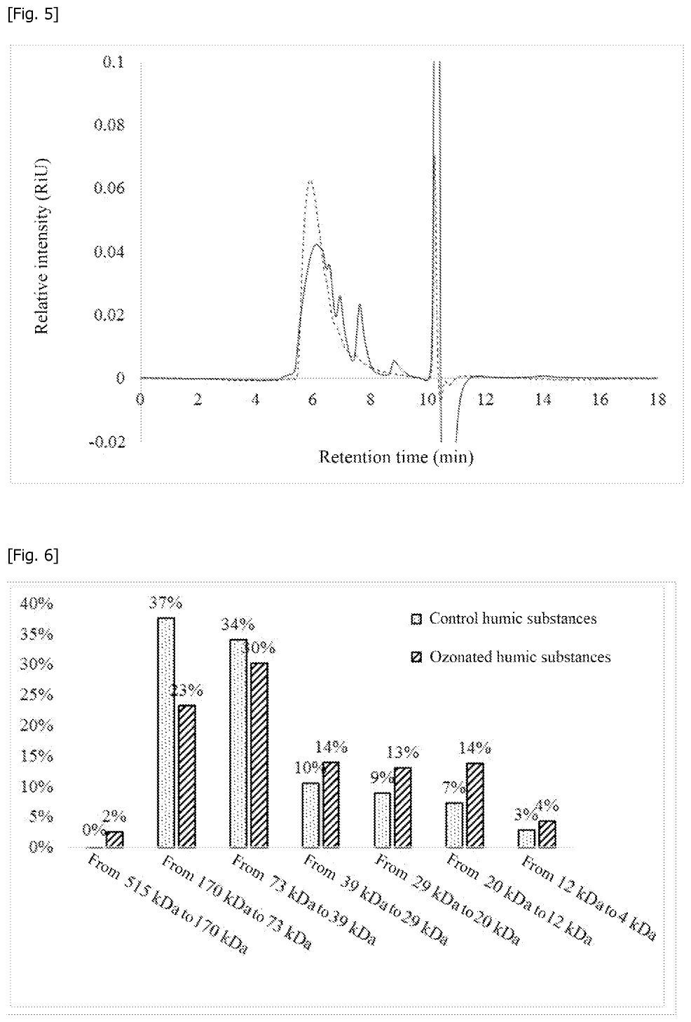

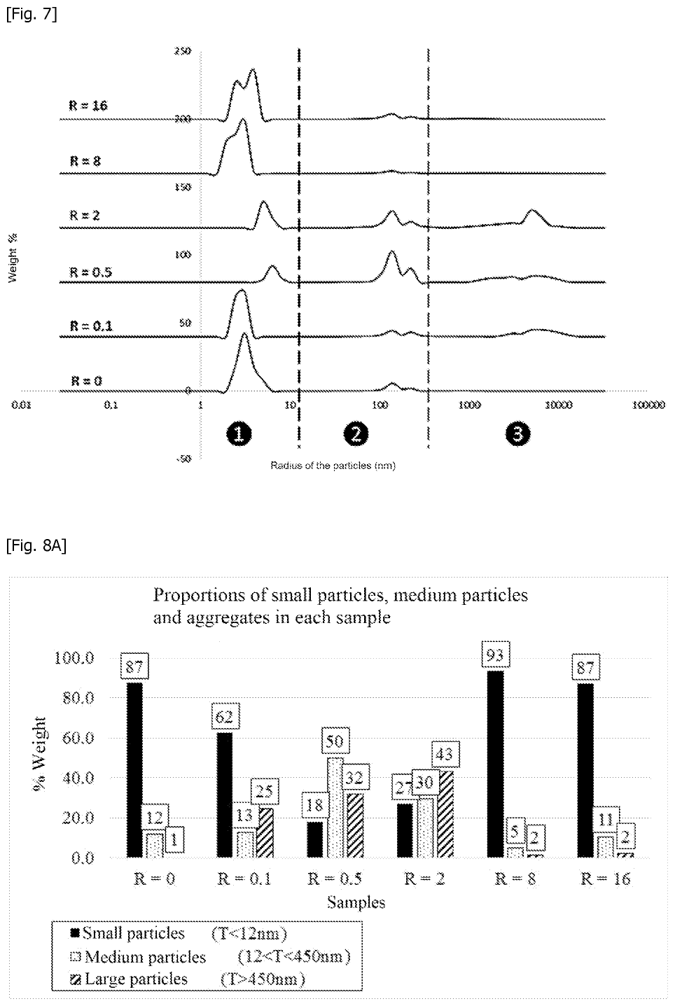

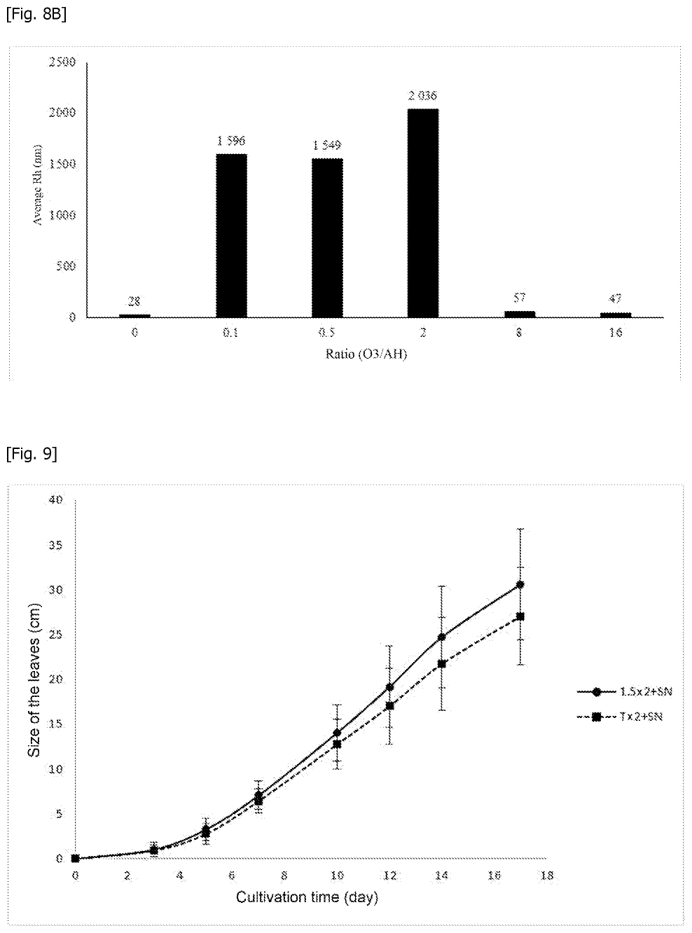

HPSEC results with RI detector are shown in FIGS. 1 and 2 (Mw and Mn) and FIGS. 5 and 6. DLS results are shown in FIGS. 7 and 8.

Mw and Mn

FIGS. 1 and 2 show the evolution of Mw and Mn during treatment with ozone.

HPSEC with Ri Detector

FIG. 5 shows that ozonation leads to a structural modification of humic substances. With regard to the aggregates, it is seen that the signal increases (around 5.2 minutes), which attests to the solubilization of certain molecules. The peak at 6 min is degraded in favor of several populations relating to smaller molar weights (at 6.6; 7.0; 7.7 and 8.9 minutes). It should be noted that the peak at 10 minutes corresponds to all the small molecules (size <100 Da) in particular the salts contained in the mobile phase of the HPLC.

FIG. 6 shows the different percentages of the different families of humic substances according to the molecular weight. FIG. 6 demonstrates an appearance of compounds with a molar weight greater than 170 kDa in the parent composition, whereas with the control composition, this family of molecules is not observed. FIG. 6 also shows that ozonation leads to the formation of smaller humic substance molecules.

DLS

FIG. 7 is a DLS (Dynamic light scattering) analysis that shows the change in size of humic substances with increasing amounts of ozone. The figure shows the appearance of molecules of humic substances with a larger hydrodynamic radius (Hr) (particle families 2 and 3) with a ratio ozone weight/humic substance weight (R) equal to 0.1, R=0.5 and R=2. With R=8, a degradation of large humic substances (family 3) into smaller molecules (families 1 & 2) is observed.

FIG. 8A is a histogram obtained from the DLS data in FIG. 7 that shows the weight distribution of humic substances as a function of their hydrodynamic radius (Hr) with increasing amounts of ozone. The figure shows that the weight proportion of particles in solution with a size comprised between 15 nm and 10000 nm increases when the ratio ozone weight/humic substance weight (R) is equal to 0.1, R=0.5 and R=2.

FIG. 8B is a histogram obtained from the DLS data in FIG. 7 that shows the weight-average hydrodynamic radius of particles in solution (Hr_{average}) with increasing amounts of ozone. The figure shows that the Hr_{average} increases when the ratio ozone weight/humic substance weight (R) is equal to 0.1, R=0.5 and R=2.

It is deduced from FIGS. 7, 8A and 8B, in particular from FIG. 8B, that the amount of ozone necessary to have an R=0.1, an R=0.5 and an R=2 corresponds to an appropriate amount of ozone within the meaning of the invention. On the other hand, the amount of ozone necessary to have an R=8 does not correspond to an appropriate amount of ozone within the meaning of the invention.

### Example 3: Effects on Plant Growth

Materials and Methods

Several compositions have been prepared:

Composition “1.5×2+SN” (ozonated humic substances): 10 liters of parent composition (Example 1) were supplemented with hydroponic solutions, namely 2.5 mL of a solution of nitrogen, phosphorus and potassium (FloraGro® from General Hydroponics), 2.5 mL of a nitrogen and calcium solution (FloraMicro® from General Hydroponics) and 2.5 mL of a solution of phosphorus, potassium, magnesium and sulfur (FloraBloom® from General Hydroponics).

Composition “T×2+SN” (non-ozonated humic substances): 10 liters of control composition (Example 1) were supplemented with hydroponic solutions, namely 2.5 mL of a nitrogen, phosphorus and potassium solution (FloraGro® from General Hydroponics), 2.5 mL of a nitrogen and calcium solution (FloraMicro® from General Hydroponics) and 2.5 mL of a phosphorus, potassium, magnesium and sulfur solution (FloraBloom® from General Hydroponics).

The composition of the FloraMicro, FloraGro and FloraBloom solutions added in the compositions of humic substances is shown in tables 2 to 4 below respectively.

TABLE 2
Composition of FloraMicro solution (NPK: 5-0-1).

| | |
|---|---|
| Total Nitrogen (N) | 5.0% |
| Ammoniacal nitrogen | 1.5% |
| Nitric nitrogen | 3.5% |
| Soluble potassium (K₂O) | 1.3% |
| Boron (B) | 0.01% |
| Calcium (CaO) | 1.4% |
| EDTA chelated copper (Cu) | 0.01% |
| 6% EDTA—11% DPTA chelated iron (Fe) | 0.12% |
| EDTA chelated manganese (Mn) | 0.05% |
| Molybdenum (Mo) | 0.004% |
| EDTA chelated zinc (Zn) | 0.015% |

TABLE 3
Composition of FloraGro solution (NPK: 3-1-6).

| | |
|---|---|
| Total Nitrogen (N) | 3% |
| Ammoniacal nitrogen | 1% |
| Nitric nitrogen | 2% |
| Available phosphate (P₂O₅) | 1% |
| Soluble potassium (K₂O) | 6% |
| Soluble magnesium (MgO) | 0.8% |

TABLE 4
Composition of FloraBloom solution (NPK: 0-5-4).

| | |
|---|---|
| Available phosphate (P₂O₅) | 5% |
| Soluble potassium (K₂O) | 4% |
| Soluble magnesium (MgO) | 3% |
| Soluble sulfur (SO₄) | 5% |

On D0, 400 maize seeds of the Amaretto variety were placed on vermiculite soaked in water in the dark for 48 hours at 30° C., in order to initiate germination.

On D2, the germinated seeds were placed in hydroponic culture according to 2 modalities (200 seeds per modality):
Modality 1:35 mL of composition “1.5×2+SN”
Modality 0:35 mL of composition “T×2+SN”

The hydroponic cultures were maintained for 16 days, with a renewal of the compositions every 2-3 days.

Results

Length of the Leaves

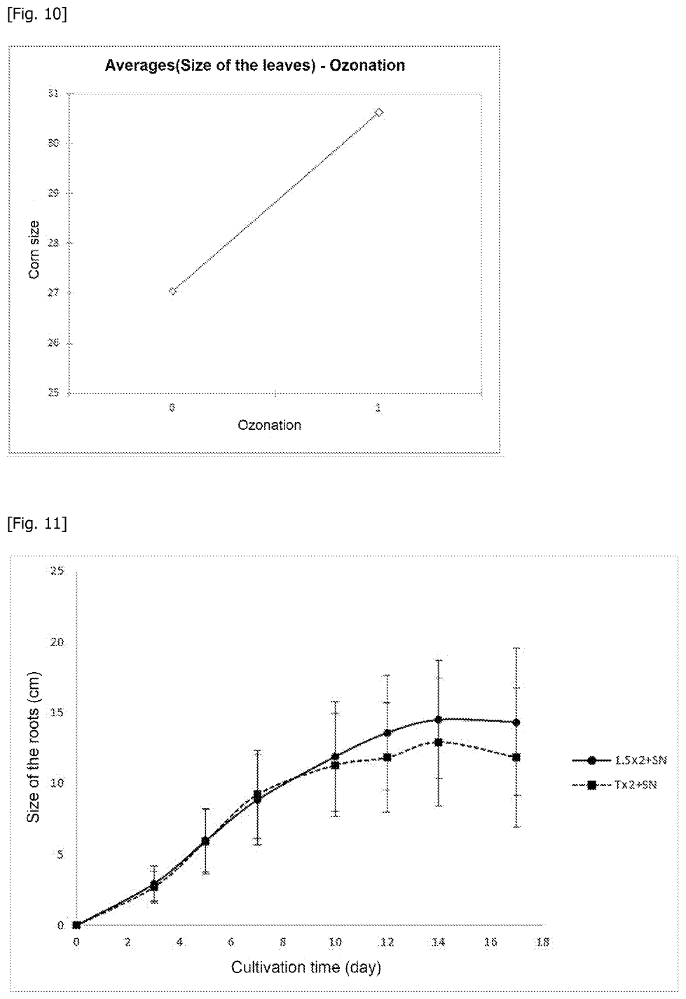

The length of the leaves was measured at each renewal of the compositions and at D16. The results are shown in FIG. 9. The average length of the leaves at D17 is shown in FIG. 10.

The results were analyzed statistically (Analysis of the differences between the modalities with a confidence interval at 95%) according to the ANOVA test. The calculations are presented in Tables 5 and 6.

TABLE 5
Statistical analyzes/Tukey (HSD)/Analysis of the
differences between the modalities with a
confidence interval at 95% (length of the leaves).

| | Differ- | Standardized | Critical | Pr > | Sig- |
|---|---|---|---|---|---|
| Contrast | ence | difference | value | Diff | nificant |
| 1 vs 0 | 3.576 | 4.381 | 1.972 | <0.0001 | Yes |
| Critical value of Tukey's d | | | 2.789 | | |
| | | | Lower | Upper | |
| | Estimated | Standard | bound | bound | |
| Modality | average | error | (95%) | (95%) | |
| 1 | 30.632 | 0.584 | 29.480 | 31.784 | |
| 0 | 27.055 | 0.570 | 25.931 | 28.179 | |

TABLE 6
Statistical analyzes/Newman-Keuls (SNK)/Analysis of the
differences between the modalities with a 95%
confidence interval (length of the leaves).

| | Differ- | Standardized | Critical | Pr > | Sig- |
|---|---|---|---|---|---|
| Contrast | ence | difference | value | Diff | nificant |
| 1 vs 0 | 3.576 | 4.381 | 1.972 | <0.0001 | Yes |
| | | | Lower | Upper | |
| | Estimated | Standard | bound | bound | |
| Modality | average | error | (95%) | (95%) | |
| 1 | 30.632 | 0.584 | 29.480 | | |
| 0 | 27.055 | 0.570 | 25.931 | 31.784 | |
| | | | | 28.179 | |

The results show that the length of the leaves is significantly greater with the composition comprising ozonated humic substances, compared to the composition comprising non-ozonated humic substances.

It was also shown that the leaf area increased significantly with the composition comprising ozonated humic substances, compared to the composition comprising non-ozonated humic substances (results not shown).

Length of the Roots

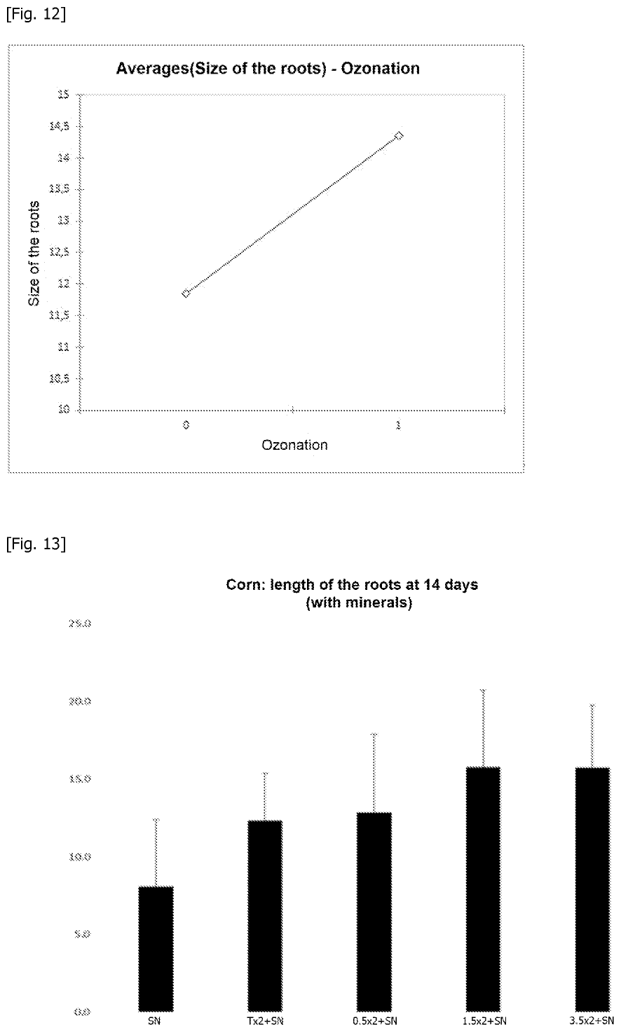

The length of the roots was measured at each renewal of the compositions and at D17. The results are shown in FIG. 11. The average length of the leaves at D17 is shown in FIG. 12.

The results were analyzed statistically (Analysis of the differences between the modalities with a confidence interval at 95%) according to the ANOVA test. The calculations are shown in Tables 7 and 8.

TABLE 7
Statistical analyzes/Tukey (HSD)/Analysis of the
differences between the modalities with a
confidence interval at 95% (length of the roots).

| | Differ- | Standardized | Critical | Pr > | Sig- |
|---|---|---|---|---|---|
| Contrast | ence | difference | value | Diff | nificant |
| 1 vs 0 | 2.508 | 3.524 | 1.972 | <0.001 | Yes |
| Critical value of Tukey's d | | | 2.789 | | |
| | | | Lower | Upper | |
| | Estimated | Standard | bound | bound | |
| Modality | average | error | (95%) | (95%) | |
| 1 | 14.356 | 0.509 | 13.352 | 15.361 | |
| 0 | 11.849 | 0.497 | 10.869 | 12.829 | |

TABLE 8
Statistical analyzes/Newman-Keuls (SNK)/Analysis of the
differences between the modalities with a confidence
interval at 95% (length of the roots).

| | Differ- | Standardized | Critical | Pr > | Sig- |
|---|---|---|---|---|---|
| Contrast | ence | difference | value | Diff | nificant |
| 1 vs 0 | 2.508 | 3.524 | 1.972 | <0.001 | Yes |
| | | | Lower | Upper | |
| | Estimated | Standard | bound | bound | |
| Modality | average | error | (95%) | (95%) | |
| 1 | 14.356 | 0.509 | 13.352 | 15.361 | |
| 0 | 11.849 | 0.497 | 10.869 | 12.829 | |

The results show that the length of the roots is significantly greater with the composition comprising ozonated humic substances, compared to the composition comprising non-ozonated humic substances.

### Example 4: Influence of the Amount of Ozone

Several compositions have been prepared:
Composition “1.5×2+SN” (ozonated humic substances ratio 1.5): see Example 3.
Composition “0.5×2+SN” (ozonated humic substances ratio 0.5): corresponds to the composition “1.5×2+SN” except that the humic substances were ozonated with a ratio ozone weight/humic substance weight of 0.5.
Composition “3.5×2+SN” (ozonated humic substances ratio 3.5): corresponds to the composition “1.5×2+SN” except that the humic substances were ozonated with a ratio ozone weight/humic substance weight of 3.5.
Composition “T×2+SN” (non-ozonated humic substances): see Example 3

On D0, 80 maize seeds of the Amaretto variety were placed on vermiculite soaked in water in the dark for 48 hours at 30° C., in order to initiate germination.

On D2, the germinated seeds were placed in hydroponic culture according to 4 modalities (20 seeds per modality):
35 mL of composition “0.5×2+SN”
35 mL of composition “1.5×2+SN”
35 mL of composition “3.5×2+SN”
35 mL of composition “T×2+SN”.

The hydroponic cultures were maintained for 16 days, with a renewal of the compositions every 2-3 days.

Results

Length of the roots was measured at D14. The results are shown in FIG. 13.

The results show that the length of the roots increases with the increase in the ratio ozone weight/humic substance weight.

Example 5: Effects on Photosynthetic Activity

The plants obtained in Example 3 were used to measure the chlorophyll and carotenoid content of the leaves by UV-Visible spectrophotometry.

Material and Methods

0.5 g of crushed leaves (mortar crushing) were placed in two vial tubes of 1 mL each. 4.5 mL of 100% MeOH solution was added to the first tube. 4.5 mL of MeOH/3% KOH solution (0.3 g of KOH diluted in 10 mL of 100% MeOH) was added to the second tube. The two tubes were then vortexed then left in ice for 15 minutes. The tubes were then centrifuged at 10000 RPM for 10 min at 4° C.

The content of each tube was deposited on a 96-well plate in 6 replicas of 300 μL per well (that is to say 6×300 μL for tube 1 and 6×300 μL for tube 2).

The absorbance of each well was measured by TECAN and analyzed on the “Tecan control” software according to the following conditions:
Tube with 100% MeOH: reading at 663 nm, 645 nm and 470 nm
Tube with MeOH/3% KOH: reading at 472 nm and 508 nm.

The carotenoid and chlorophyll A and B contents were measured according to the following equations:

Carotenoids (in μg/mL)=(A₄₇₂×1724.3−A₅₀₈×2450.1)/270.9

Chlorophyll A (in μg/mL)=16.72×A₆₆₃−9.16×A₆₄₅

Chlorophyll B (in μg/mL)=34.09×A₆₄₅−15.28×A₆₆₃

Results

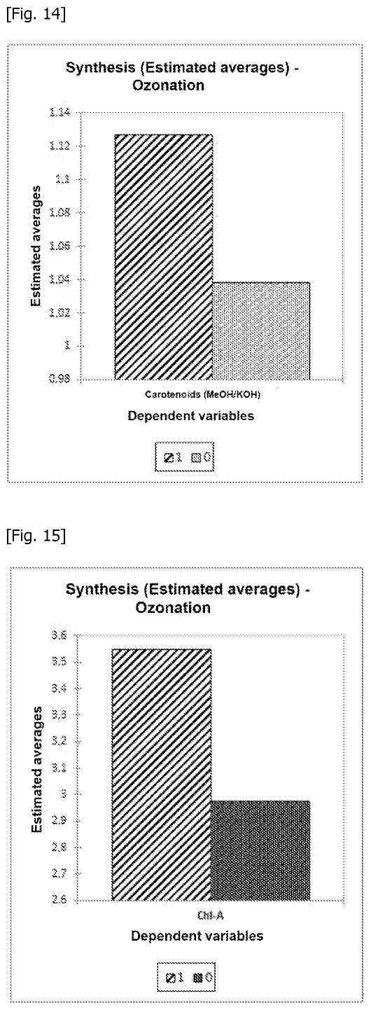

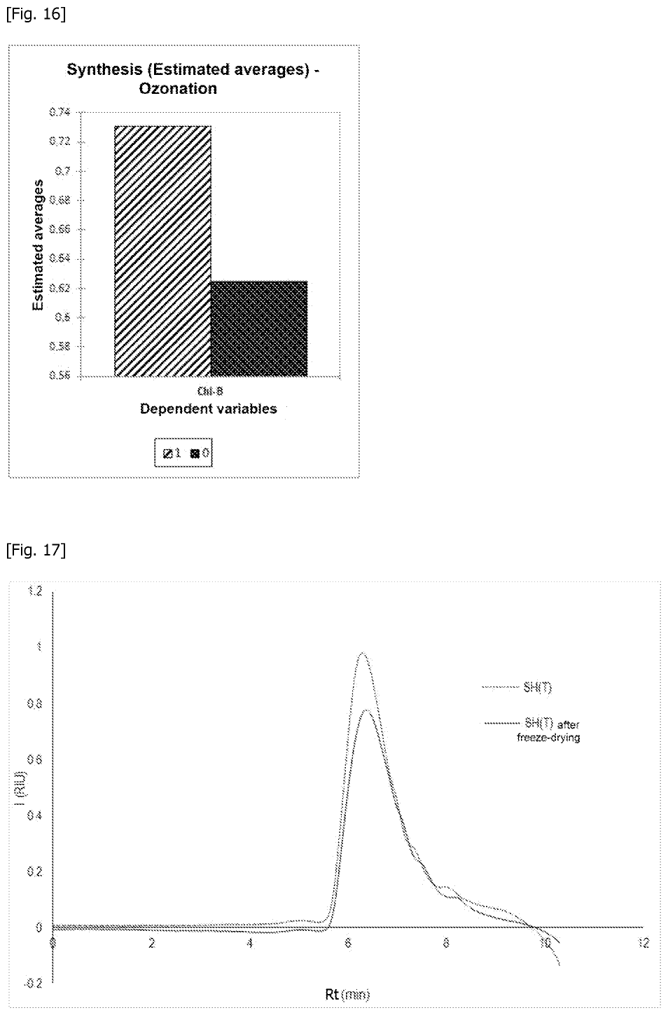

The results are shown in FIGS. 14 to 16 and in Table 9 below.

TABLE 9

| | Chl-A | Chl-B | Chl-A + B | Carotenoids |
|---|---|---|---|---|
| With ozonation | 3.550 | 0.731 | 4.280 | 1.127 |
| Without | 2.976 | 0.625 | 3.601 | 1.038 |
| ozonation | | | | |
| Pr > F | <0.0001 | <0.0001 | <0.0001 | <0.0001 |
| Significant | Yes | Yes | Yes | Yes |

The results show that the carotenoid and chlorophyll contents increase when the maize is treated with the composition comprising ozonated humic substances, compared to the composition comprising non-ozonated humic substances.

### Example 6: Physico-Chemical Analyzes of Control and Ozonated Humic Substances

Effect of Freeze-Drying

The purpose of freeze-drying is to determine whether the transition to the solid state of ozonated humic substances induces intra and inter molecular rearrangement. If so, it can be deduced that the molecules should be used in solution and not in the form of solids.

Protocol

15 mL of the “control” and “parent” compositions of Example 1 were freeze-dried. The freeze-dried compositions were then dissolved in 15 mL of MilliQ water. The solutions thus obtained were then analyzed by HPSEC.

HPSEC Results

FIG. 17 shows the curves obtained for the non-ozonated composition. The figure shows that the curves are similar, the two profiles being relatively close. Freeze-drying has little influence on non-ozonated humic substances (figure below).

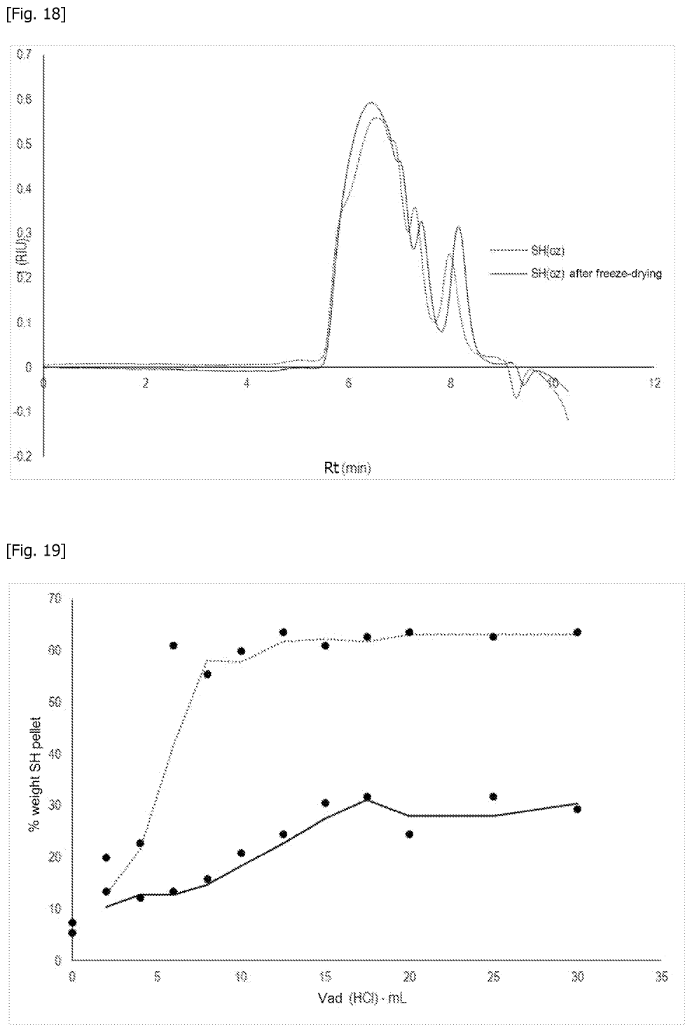

In the case of ozonated humic substances (FIG. 18), differences similar to those obtained with non-ozonated humic substances were obtained. There was an 8 second lag between the two curves. In addition, the intensity of the peak at 8 min was greater after freeze-drying for ozonated humic substances. Apart from these differences, the curves are similar.

The humic substances ozonated according to the method of the invention are very stable and withstand freeze-drying. The ozonated humic substances according to the invention can therefore be prepared both in liquid form and in solid form (freeze-dried form) without alteration.

Solubility of Humic Substances as a Function of pH

Protocol

The “control” and “parent” compositions of Example 1 were used. The compositions were placed in vials and acidified with increasing volumes of 0.1 mol/L HCl. The vials were weighed beforehand empty (mᵥᵢₐₗ). All the acidified compositions were then stirred then centrifuged. The pellets and the supernatants were separated, the pH of the supernatant was measured, the pellet itself was dried in an oven. The vials were then weighed with the pellet (mₚₑₗₗₑₜ+mᵥᵢₐₗ). The weighings were made once the samples returned to room temperature.

For each sample, the weight percentage of humic substances was calculated according to the following formula:

% SH_{by weight}=((mₚₑₗₗₑₜ+mᵥᵢₐₗ)−mᵥᵢₐₗ)×100/m_{initial SH}
with:
% SH_{by weight}=% of insoluble humic substances
mₚₑₗₗₑₜ=weight of the pellet
mᵥᵢₐₗ=weight of the empty vial
m_{initial SH}=weight of humic substances placed in the vial before acidification.

Results

pH was measured for all samples. Except for the sample without HCl addition for which the difference is significant (3 pH units), the other pH values were relatively close to each other for the same volume of HCl added.

FIG. 19 shows that the more the solution was acidified, the more the humic substances tended to precipitate. However, the non-ozonated humic substances were precipitated up to 60% while the ozonated humic substances were only precipitated at 30%. Ozonation therefore improved the solubility of humic substances in acid pH.

### BIBLIOGRAPHY

[1] Y. Karakurt, H. Unlu, H. Unlu, H. Padem, The influence of foliar and soil fertilization of humic acid on yield and quality of pepper, Acta Agric. scand. sect. B Soil Plant Sci. 59 (2009) 233-237.
[2] B. L. Loeb, C. M. Thompson, J. Drago, H. Takahara, S. Baig, Worldwide Ozone Capacity for Treatment of Drinking Water and Wastewater: A Review, Ozone Sci. Eng. 34 (2012) 64-77.
[3] A. A.-P. Pascual A. A4—Llorca, I. A4—Canut, A., Use of ozone in food industries for reducing the environmental impact of cleaning and disinfection activities, Trends Food Sci. Technology. v. 18 (2007) S29-S35-2007 v. 18.
[4] M. Bataller, E. Veliz, R. Pérez-Rey, LA Fernandez, M. Gutierrez, A. Márquez, Ozone swimming pool water treatment under tropical conditions, Ozone Sci. Eng. 22 (2000) 677-682.
[5] Stevenson, 1994, Humus Chemistry, Second edition, Wiley, New York (https://books.google.fr/books/about/Humus_Chemistry.html?id=7kCQch_YKoMC&redir_esc=y).
[6] X. Zhong and al. Formation of Aldehydes and Carboxylic acids in humic add ozonation. Water Air Soil Pollut. (2017) p 228.
[7] Hanninen and al., 1987, The Science of the Total Environment, 62, 201-210
[8] Fuentes M., Simultaneous Presence of Diverse Molecular Patterns in Humic Substances in Solution, J. Phys. Chem. B (2007) 111, 35, 10577-10582.
[9] Les amendements organiques, Utilisation des matières organiques en construction (http://www.alaindehaye.com/Amendements%20organi.%205.PDF).
[10] Saito and al., Alkaline Extraction of Humic Substances, Brazilian Journal of Chemical Engineering, Vol. 31, No. 03, pp. 675-682, July-September, 2014.
[11] Bhattacharjee S. DLS and zeta potential—What they are and what they are not? Journal of Controlled Release (2016) 235, 337-351.

1. A method for preparing a fertilizing composition, comprising a step of treating a liquid composition having humic substances the weight-average hydrodynamic radius of the particles in solution of which, measured by dynamic light scattering (DLS), is the “Hr_{average pre-treatment}” with an appropriate amount of oxidizing agent to obtain a liquid composition having oxidized humic substances the weight-average hydrodynamic radius of the particles in solution (Hr_{average post-treatment}) of which, measured by DLS, is greater than the Hr_{average pre-treatment}.

2. The method according to claim 1, said liquid composition having humic substances is obtained from peat, leonardite, lignite, coal or anthracite.

3. The method according to claim 1, said liquid composition having humic substances comprises at least 50% by dry weight of humic substances.

4. The method according to claim 1, said oxidizing agent is selected from ozone, ultraviolet rays and/or hydrogen peroxide.

5. The method according to claim 1, said Hr_{average post-treatment} is at least 5 times higher than the Hr_{average pre-treatment}.

6. The method according to claim 1, characterized in that the weight proportion of particles in solution having a hydrodynamic radius comprised between 15 nm and 10000 nm of the composition having oxidized humic substances, measured by DLS, is at least 2 times greater than the weight proportion of particles in solution having a hydrodynamic radius comprised between 15 nm and 10000 nm of the composition having humic substances before oxidation.

7. A fertilizing composition that can be obtained by the method according to claim 1.

8. The fertilizing composition according to claim 7, characterized in that the weight-average hydrodynamic radius of the particles in solution (Hr_{average}), measured by DLS, is greater than 50 nm.

9. The composition according to claim 7, characterized in that the weight proportion of particles in solution having a hydrodynamic radius comprised between 15 nm and 10000 nm, measured by DLS, is greater than 15%.

10. The composition according to claim 7, further comprising one or more mineral fertilizers, preferably containing one or more minerals selected from nitrogen, phosphorus, potassium, calcium, magnesium and sulfur.

11. A stimulant comprising the composition according to claim 7 for the absorption of minerals in a plant, preferably the minerals are selected from nitrogen, phosphorus, potassium, calcium, magnesium and/or sulfur.

12. A stimulant comprising the composition according to claim 7 for the production of pigments in a plant, preferably the production of carotenoids, chlorophyll A and/or chlorophyll B.

13. The stimulant according to claim 11, for stimulating aerial and/or root growth of the plant.

14. A method for fertilizing a plant, a soil or a growing medium comprising applying the composition according to claim 7 to the plant, to said soil or to said growing medium.

15. A method for fertilizing a plant, a soil or a growing medium consisting of:
preparing a fertilizing composition by implementing the method according to claim 1, and
applying said fertilizing composition to the plant, to the soil or to the growing medium.

16. The method according to claim 14, characterized in that the application to the plant, to the soil or to the growing medium allows to stimulate the absorption of minerals in a plant and/or to stimulate the production of pigments in the plant.

17. The method according to claim 14, characterized in that the composition is applied to an acid soil.

18. The stimulant according to claim 12, for stimulating aerial and/or root growth of the plant.
